(19) United States
(12) Patent Application Publication
(10) Pub. No.: US 2009/0326691 A1
(43) Pub. Date: Dec. 31, 2009

(54) Programmable sound player

(76) Inventors: Melissa V. Downes, North Sydney (AU); Christopher Peters, Glen Iris Vicoria (AU)

Correspondence Address: ABELMAN, FRAYNE & SCHWAB, 666 THIRD AVENUE, 10TH FLOOR, NEW YORK, NY, 10017, US

(21) Appl. No.: 12/454,238

(22) Filed: May 13, 2009

(30) Foreign Application Priority Data
May 13, 2008 (AU) 2008902351

(51) Int. Cl. G06F 17/00

(52) U.S. Cl. 700/94

(57) ABSTRACT

The present invention relates generally to a programmable sound player comprising a body member, which for a substantial part is of roughly spherical ellipsoid shape; a base member joined to the body member, for resting on a planar surface; a plurality of function buttons disposed on a bottom surface of the base member, wherein each function button is adapted to be illuminated by a light source under the function buttons; wherein one of the function buttons is configured to activate a sound playing mode and a sound recording mode.

### TECHNICAL FIELD

The present invention relates generally to a programmable sound player for nurseries or hospitals. In particular, the present invention relates to a programmable sound player with a contour and a plurality of functions customised for nurseries or hospitals.

### BACKGROUND ART

Music is a familiar part of Australian life. People of any age or ability may benefit from music regardless of the individual musical skill or background. They are always exposed to recorded music on radio, television, compact discs and tapes. Music is played everywhere—in shops, sporting events, fitness regimes, TV, radio and movies—and may be taken for granted. Most people also choose to have music for relaxation. Music may also address physical, psychological, emotional, cognitive and social needs of individuals.

It is not surprising that human beings have a special relationship to music. In our heartbeat, in our breathing and movement there is rhythm. Both pitch and rhythm give the human voice vital and expressive characteristics for communicating meaning and intention.

Scientific research demonstrates that music can deliver positive effects to certain people. Passive music can calm people down and induce sleepiness. Hyperactive people will benefit if passive music is played softly in the background, encouraging them to sleep well, whilst increasing memory and concentration span. While active music can stimulate the human's brain, it will ensure that neither sleep nor stress is present in the brain.

In view of this theory, people may choose to more actively expose themselves to audio stimuli, in particular, in a relaxing or hypnagogic environment, using a sound device designed for this purpose.

Illustrative of such music devices are U.S. Pat. No. 6,692,330 (Kulick) and U.S. Pat. No. 5,027,457 (Sweet). Kulick discloses an infant toy having a sound “record” and “play” functions, which can comfort an infant when necessary and turn itself off after the infant has fallen asleep. Sweet discloses a pillow that may include means of emitting sound such as a pull string or voice-activated tape player.

It would be desirable to provide a programmable sound player that ameliorates or overcomes one or more known disadvantages of existing techniques or that may provide a useful alternative to them.

### DISCLOSURE OF THE INVENTION

These and other advantages are met with the present invention, which in one broad form concerns a programmable sound player that comprises:

a body member, which for a substantial part is of roughly spherical ellipsoid shape;

a base member joined to the body member, for resting on a planar surface; and

a plurality of function buttons disposed on a bottom surface of the base member.

Preferably, each function button is adapted to be illuminate by a light source under the function buttons.

Preferably, one of the function buttons is configured to activate a sound playing mode and a sound recording mode.

Preferably, the programmable sound player further comprises:

a light source for illumination, and

a light button disposed on the bottom surface of the base member, wherein the light button is configured to turn on and off the white light source.

Preferably, the programmable sound player further comprises:

a timer for halting the programmable sound player after a stop time interval,

a timer button disposed on the bottom surface of the base member, wherein the timer button is configured to set the stop time interval;

one or more displays disposed on the bottom surface of the base member, wherein the displays are configured to indicate the length of the stop time interval.

Preferably, the programmable sound player further comprises an input interface for receiving signals from an external device, such that when the external device is connected to the input interface, the sound playing mode will stop and the signal from the external device will be played.

It is preferred that the sound playing mode includes playing the sound of fauna, heart beats, the womb, white noise, ocean waves, fans, rain, ambient background sounds or ambient music.

### BRIEF DESCRIPTION OF DRAWINGS

The invention is now discussed with reference to drawings, where:

FIG. 1 is a schematic perspective front view of a preferred embodiment of a programmable sound player of the present invention;

FIG. 2 is a schematic perspective rear view of the programmable sound player of FIG. 1;

FIG. 3 is a schematic rear plan view of the programmable sound player of FIG. 1;

FIG. 4 is a schematic inverted plan view of the programmable sound player of FIG. 1;

FIG. 5 is a schematic inverted perspective view of the programmable sound player of FIG. 1; and

FIG. 6 is a schematic plan view of the function buttons of the programmable sound player of another preferred embodiment.

### BEST MODES FOR CARRYING OUT THE INVENTION

The present invention is a programmable sound player, which provides an aesthetic pleasing appearance and sound, particularly for a relaxing or hypnagogic environment. This programmable sound player comprises a sound reproduction system incorporated into a sleek receptacle with a user friendly interface adapted to facilitate the operation of the programmable sound player in a light deficient surrounding.

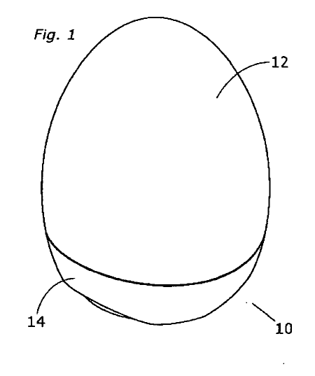

The sound player according to the present invention is indicated in FIGS. 1 to 5 by reference numeral 10. The sound player 10 comprises a sleek body 12, which for a substantial part is of a prolate and roughly spherical ellipsoid shape. A base member 14 is joined to the body 12, which allows the sound player to rest stably on a planar surface such as the top of the bedside table.

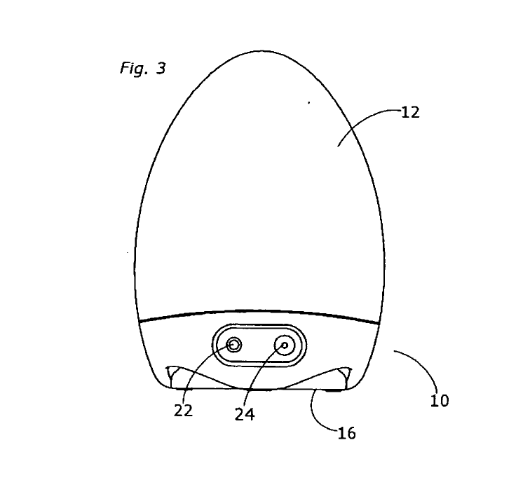

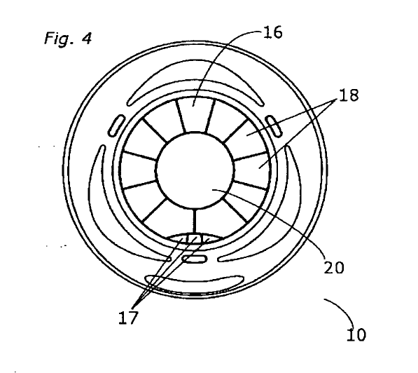

The base member 14 is substantially circular. As shown in FIGS. 3 and 4, the bottom surface 16 of the base member 14 comprises a plurality of function buttons 18 along the circumference of the bottom surface. In addition, there is a round button 20 located at the centre of the bottom surface 16, such that it is surrounded by the function buttons 18.

These buttons are the user interfaces for the user to control the functions of the sound player 10. Typically they are in the form of momentary buttons. These momentary buttons can be latched but they do not latch into the up or down position permanently. Each button has a backlight, so that they can be recognized easily in a dark place.

Preferably, the round button 20 is programmed to control the power on and power off of the sound player 10. The round button 20 is often designed to be comparatively bigger than the function buttons 18 around it. The position and the size of the round button 20 therefore make it easy for the user to locate it in a dark environment, even without the backlight illumination.

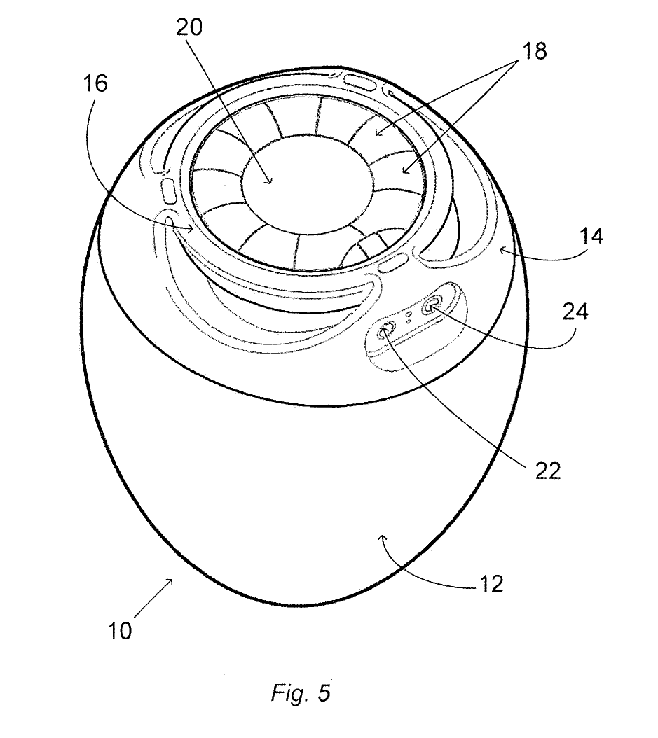

Also located at the bottom surface 16, there is a plurality of displays 17 to indicate the state of the sound player 10. These displays 17 can be LED or LCD displays. In one embodiment, three LED displays 17 are installed near the function buttons 18 as shown in FIGS. 4 and 5. The functions of each of the displays 17 can be programmed to indicate different states of the sound player 10.

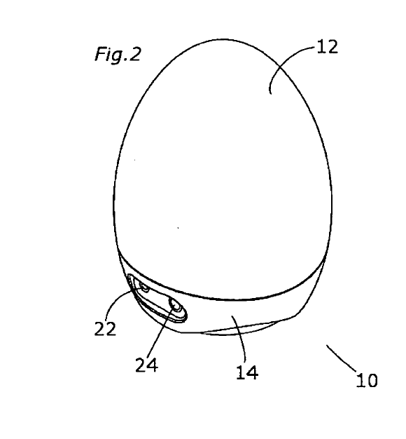

On the side of the base member 14, there is at least one input interface 22 for receiving signals from an external device. In one embodiment, as shown in FIGS. 2, 3 and 5, this input interface is in the form of a TRS connector. Other kinds of connector, such as MIDI connectors or USB connectors, can also be installed.

In one preferred embodiment, a front display 24, such as an LED or LCD display, is installed next to the input interface 22. The front display 24 is also configured to indicate the state of the sound player. In a preferred embodiment, this display is programmed to indicate the on and off state of the sound player. In another embodiment, it is adapted to indicate that the sound player is currently in the play mode or record mode. It can also display the current time or alarm time in another embodiment.

The sound player 10 comprises at least one speaker, preferably a high quality 2.5″ full range magnetically shielded speaker with 100-20 KHz or 50 ˜20 KHz output, which is designed to provide optimal sound performance with the ovoid contour of the sound player 10; and an internal microphone for recording the surrounding sound or voice. The sound player 10 also has a light source such as illumination LED to illuminate the environment. It is preferred that the illumination LED is in white colour.

The power input unit of the sound player is preferably a DC power input unit. Optionally, a rechargeable power unit can be installed. If a rechargeable power unit is utilized, the power input unit can also have an AC power input unit for supplying constant power to the sound player 10 and recharging the rechargeable power unit.

The sound player 10 also comprises a signal processing module, memory storage and an amplifier. The signal processing module controls the functions of the sound player. These functions can be altered through the signal processing module.

In this preferred embodiment, the functions include playing the music stored in the memory storage, recording music to the memory, increasing or decreasing the sound volume of the sound output, providing a timer to start or stop the function of the sound player.

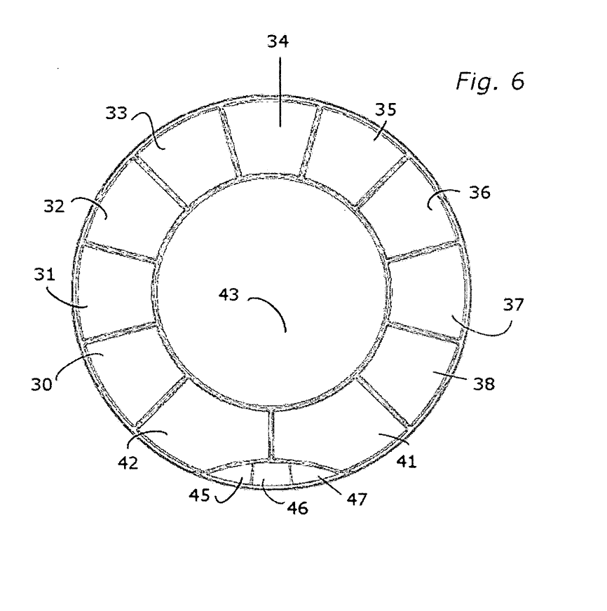

FIG. 6 shows one embodiment of the present invention, which has all the functions 18 assigned, each to a different function.

The night light button 30 controls the night light of the sound player. The night light button 30 is configured to turn the night light on if the previous state of the night light is off. The night light button 30 is configured to turn off the night light if the previous state of the night light is on.

The night light is programmable to be turned on and off by the sound player. When the sound player is turned on, it will turn the night light on. However, the night light can also manually be turned off or programmed to turn off after a period of time set by the timer. When the sound player is turned off, it will turn off the night light as well.

When the sound player is turned on and the night light is already on, the night light will stay on. When the sound player is off, the state of the night light will be clear.

Sound buttons 31 to 36 have similar function. They are configurable to play pre-recorded sound samples which are stored in the memory storage of the sound player 10. These pre-recorded sound samples are preferably provided by the factory. In one embodiment, the factory provides the music samples, such as the sound of ocean waves. Typically, only one sound sample can be played at one time. The sound player 10 will continue playing a selected sound sample until the sound player is turned off manually or by the timer. It is possible to switch sound playing modes at any time when the sound player 10 is on and the interface input 22 is not plugged in.

Referring to FIG. 6, sound button 30 controls the on and off buttons of the light source for illuminating the environment; sound button 31 is configured to activate the sound player to play the sound of heart beat/womb; sound button 32 is configured to activate the sound player to play the sound of serenity; sound button 33 is configured to activate the sound player to play white noise; sound button 34 is configured to activate the sound player to play the sound of ocean waves; sound button 35 is configured to activate the sound player to play the sound of a fan; sound button 36 is configured to activate the sound player to play the sound of rain.

When any one of the sound buttons 31 to 36 is activated, and an external musical device is connected to the input interface 22, the sound playing will stop and the sound player 10 will start playing the signal from the interface input. Connecting or disconnecting the interface input 22 does not affect the timer. When disconnecting the input interface 22, the previous sound will continue to play.

Customised sound button 37 is configured to provide the function of playing or recording customised sound. It allows users to record a customised sound to play back. When the customised sound button 37 is pressed momentarily (for less than 3 seconds), the sound player 10 will play the last recorded sound stored in the memory storage. Initially, the sound player 10 has a default recorded sound stored in the memory storage. When the recording function starts, the signal processing module will receive signal from the microphone or the input interface 22.

In one embodiment, the default recorded sound is a message, such as:—

“To record a customised sound please press and hold the custom sound button for 3 seconds. A chime will sound when it's ready to start recording.”

When the customised sound button 37 is pressed and held for longer than 3 seconds, the sound player will erase any previous recorded sound and start recording a new sound.

To indicate that the sound player 10 is about to start recording, the sound player will first make a chime. It will then start recording until the memory storage is full or the customised sound button 37 is pressed again. When the memory storage is full, the sound player 10 will play another chime to Indicate that it has completed recording. The customised sound button 37 will illuminate and flash in red when recording.

When the customised sound is being played back, the sound player will only replay the recorded part of the memory. Empty parts in memory will not be played.

Timer button 38 controls the timer function of the sound player 10. In the preferred embodiment shown in FIG. 6, the displays 17 are in the form of LEDs 45, 46 and 47 and they are configured to indicate the state of the timer. The first LED 45 is configured to indicate the timer is set to 15 minutes. The second LED 46 is configured to indicate the timer is set to 30 minutes. The third LED 47 is configured to indicate the timer is set to 45 minutes.

The timer button 38 operates when the sound player 10 is on (playing sound, night light on or off) or when just the night light is on. When the timer is not set the sound player 10 will stay on continuously. When the timer is set, it will power off the sound player 10 or the night light after a certain time period.

The timer button 38 cycles through four settings with each time the timer button is pressed.

1. No timer (default setting, ALL timer LEDs off)

2. 15 min timer (15 min timer LED 45 on, 30 and 60 min LED off)

3. 30 min timer (30 min timber LED 46 on, 15 and 60 min LED off)

4. 60 min timer (60 min timber LED 47 on, 15 and 30 min LED off)

Other combination of time intervals can also be set, such as 45 minutes, 75 minutes, 90 minutes and 105 minutes, etc.

When the timer is set, the sound player 10 and the night light will turn off when the timer runs out. When the night light is on, the sound player 10 is off and the timer has been set, the night light will turn off when the timer runs out.

The timer will turn off when the sound player 10 is turned off. If the night light is on with the timer set, the timer will be cancelled when the night light button 30 is pressed and the light will turn off. Also if the sound player 10 is on (playing sound, night light on/off) with the timer set, the timer will be cancelled when the sound player is turned off.

When the sound player 10 is switched on while the night light is already on and the timer is set, the timer will continue counting down. In all cases, when the timer runs out the sound and the light should fade down gently over a period of time, for example, 5 seconds.

Next to the timer LEDs 45, 46 and 47 are two volume control buttons 41 and 42. Volume control button 41 is configured to increase the sound volume of the sound player while volume control button 42 is configured to decrease the sound volume of the sound player.

Located at the centre of the abovementioned buttons 30 to 42 is the power button 43. Power button 43 is configured to turn the sound player 10 on and off depending on the current state of the sound player.

The buttons 30 to 42 will be rear illuminated by back lighting such as white LEDs. When the sound player is turned on, the button back lighting will turn on. If no buttons have been pressed for more than 10 seconds, the back lighting should fade away to be completely off. If the sound player 10 is on and the back lighting is off, the back lighting will turn on when any button is pressed and start the 10 second count again.

In another embodiment, the back lighting of the buttons is on constantly when the sound player is on. The back lighting will fade to a low glow if no buttons are pressed for a period of time, for example 5 seconds. When any button is pressed, the back lighting will revert to full brightness.

Unless the context indicates otherwise, the words “comprise” or “comprising” and the like terms should be construed in an inclusive sense, as contrasted to an exclusive or exhaustive sense. These words normally mean “including but not limited to”.

It will be apparent that obvious variations or modifications may be made in accordance with the spirit of the invention that are intended to be part of the invention, and any such obvious variations or modification are therefore within the scope of the invention.

1. A programmable sound player comprising:
a body member, which for a substantial part is of roughly spherical ellipsoid shape;
a base member joined to the body member, for resting on a planar surface; and
a plurality of function buttons disposed on a bottom surface of the base member.

2. The programmable sound player of claim 1, wherein each function button is adapted to be illuminated by a light source under the function buttons.

3. The programmable sound player of claim 1, wherein one of the function buttons is configured to activate a sound playing mode and a sound recording mode.

4. The programmable sound player of claim 1, further comprising a signal processing module adapted to control the functions of sound player.

5. The programmable sound player of claim 4, further comprising memory storage adapted to store multiple sound samples for playing.

6. The programmable sound player of any of the preceding claims claim 5 further comprising a light source for illumination.

7. The programmable sound player of claim 6, wherein the light source is controllable by the signal processing module, such that if the light source can be turned on automatically when the sound player is on.

8. The programmable sound player of claim 6, further comprising a light button disposed on the bottom surface of the base member, wherein the light button is configured to turn on and off of the light source.

9. The programmable sound player of claim 6, wherein the light source is a white colour light source.

10. The programmable sound player of claim 6, wherein the light source is configurable to fade into low glow within another predetermined period of time.

11. The programmable sound player of claim 6, wherein the light source is configurable to fade out gradually within a predetermined period of time.

12. The programmable sound player of claim 1, further comprising a central button located on the bottom surface of the base member, wherein said central button is bigger in size than each of the function buttons.

13. The programmable sound player of claim 12, wherein the central button is configurable to activate and deactivate the sound player.

14. The programmable sound player of claim 1, further comprising:
a timer for halting the programmable sound player after a stop time interval; and
a timer button disposed on the bottom surface of the base member, wherein the timer button is configured to set the stop time interval.

15. The programmable sound player of claim 1, further comprising one or more displays disposed on the bottom surface of the base member, wherein at least one display is configured to indicate the length of the stop time interval.

16. The programmable sound player of claim 3, further comprising an input interface for receiving signals from an external device, such that when the external device is connected to the input interface, the sound playing mode will stop and the signals from the external device will be played.

17. The programmable sound player of claim 3, wherein the sound playing mode includes playing the sound of fauna, heart beats, the womb, white noise, ocean waves, fans, rain, ambient soundscapes and ambient music.

18. The programmable sound player of claim 3, wherein the sound playing mode is configured to continue playing a selected sound sample until the sound playing mode is deactivated.
